(19) United States
(12) Patent Application Publication
(10) Pub. No.: US 2024/0306229 A1
(43) Pub. Date: Sep. 12, 2024

(54) TRANSMISSION OF COVERAGE INDICATOR WITH RELAY CAPABILITY BY RELAY USER EQUIPMENT (UE) DEVICES

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/271,028

(22) PCT Filed: Jan. 13, 2022
(86) PCT No.: PCT/US2022/012298

§ 371 Date: Jul. 5, 2023

Related U.S. Application Data
(60) Provisional application No. 63/137,336, filed on Jan. 14, 2021.

(51) Int. Cl. H04W 76/14; H04W 40/20; H04W 40/22; H04W 88/04

(52) U.S. Cl. CPC H04W 76/14; H04W 40/20; H04W 40/22; H04W 88/04

(57) ABSTRACT

Relay user equipment (UE) devices transmit coverage indicators to notify remote UE devices of coverage status and relay capability. Each coverage indicator may include an indication that the relay UE device is in coverage of cell and identification of the cell. For the examples, the coverage indicator indicates the relay capability of the relay UE device with an indication on whether the relay UE device is capable of providing U2U relay service to a target UE device. U2N relay service to a base station, or both U2U and U2N relay service. A remote UE device searching for a preferred relay UE device evaluates the conditions based on the information provided in the coverage indicators to select a preferred relay path from two or more relay paths through candidate relay UE devices.

### CLAIM OF PRIORITY

The present application claims the benefit of priority to Provisional Application No. 63/137,336 entitled “Discovery Resource for Relaying”, docket number TPRO 00355 US, filed Jan. 14, 2021, assigned to the assignee hereof and hereby expressly incorporated by reference in its entirety.

### FIELD

This invention generally relates to wireless communications and more particularly to management of wireless communication links using relay devices.

### BACKGROUND

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D). In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying and the relay UE device establishes a communication path between the remote UE and a base station (gNB) or cell. In some situations, for example, the UE device may be out of the service area of the base station and the relay UE device provides a communication link routed from such an out-of-coverage (OoC) UE device through a relay UE device to the base station. Where the destination device another UE device (target UE device), the relaying functionality is typically referred to as UE-to-UE (U2U) relaying.

### SUMMARY

Relay user equipment (UE) devices transmit coverage indicators to notify remote UE devices of coverage status and relay capability. Each coverage indicator may include an indication that the relay UE device is in coverage of cell and identification of the cell. For the examples, the coverage indicator indicates the relay capability of the relay UE device with an indication on whether the relay UE device is capable of providing U2U relay service to a target UE device, U2N relay service to a base station, or both U2U and U2N relay service. A remote UE device searching for a preferred relay UE device evaluates the conditions based on the information provided in the coverage indicators to select a preferred relay path from two or more relay paths through candidate relay UE devices.

### BRIEF DESCRIPTION OF THE DRAWINGS

FIG. 1 is a block diagram of communication system 100 for an example where relay UE devices each transmit a cell coverage indicator.

FIG. 2 is a block diagram of an example of a coverage indicator suitable for use in the examples discussed herein.

FIG. 3 is a block diagram of the system for an example where the remote UE device has received the cell coverage indicators from the candidate devices and is evaluating the paths to connect to the target UE device.

FIG. 4 is a message diagram for an example of discovery message transmission including coverage and relay capability information.

FIG. 5 is a block diagram of an example of a base station suitable for use as both the base stations and any base station serving any of the UE devices.

FIG. 6 is a block diagram of an example of a UE device suitable for use as each of the UE devices.

FIG. 7 is a flow chart of an example of a method of selecting a relay UE device based on coverage information.

### DETAILED DESCRIPTION

As discussed above, a relay UE device provides connectivity between a remote UE device and a destination which can be another UE device (destination UE device) or a network. Where the destination is the network, the relay provides connectivity to a cell provided by a base station (gNB) of the network. The relayed connection between a remote UE device and target UE device is sometimes referred to as a UE to UE (U2U) relay connection. The relayed connection between a remote UE device and a base station (gNB) is sometimes referred to as a UE to network (U2N) relay connection. In some situations, the ultimate destination is a target UE device where multiple paths are available to the target. The paths may include paths with a single relay UE device, paths with multiple relay UE devices, paths with a single base station, and paths with one or more relay UE devices and a base station as well as other combinations. In conventional systems where the relay connects to a base station (gNB), the relay UE device is required to meet certain criteria to function as a relay. For example, the relay UE device must be in coverage and have a cellular (Uu) communication link to the base station of sufficient quality in order to be available for U2N relaying functions. For U2N relaying, therefore all candidate relay devices are assumed to be within coverage of the base station (gNB). With U2U relaying, typically there is no such restriction and the relay UE device may be in coverage or OoC of the cell. In conventional systems, it may not be clear to the remote UE device whether a particular relay UE device is in coverage when evaluating multiple candidate relay devices for a preferred path to a target UE device.

For the examples herein, candidate relay UE devices each transmit a coverage indicator as part of their discovery announcements. The coverage indicator at least indicates whether the relay UE device is in coverage of cell and, in the examples herein, also indicates a relay capability of the candidate relay UE device. A remote device considering a candidate relay UE device evaluates the different paths to a target UE device. For example, the remote UE device may evaluate the potential paths based on reliability, latency and a flexibility of the relay UE device for switching paths.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17).

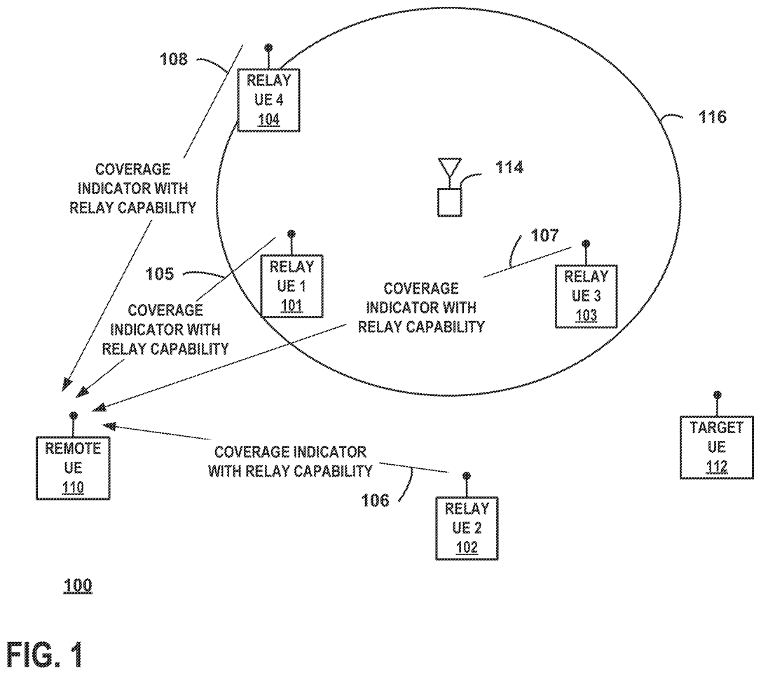

FIG. 1 is a block diagram of communication system 100 for an example where relay UE devices 101-104 each transmit a cell coverage indicator 105, 106, 107, 108. For the examples, the coverage indicators 104-108 are transmitted as part of discovery message. The discovery message may be a Model A discovery announcement, a Model B discovery announcement, or a Model B discovery response. The coverage indicators 104-108, therefore, can be received by any UE device that can receive the discovery messages. For the example, a remote UE device 110 receives the coverage indicators where the remote UE device 110 is searching for a relay UE device for establishing (or maintaining) communication with a target UE device 112. The remote UE device 110, therefore, may be performing relay selection or a relay reselection. A base station 114, such a gNB, provides a cell 116 and the remote UE device 110 is located out of coverage (OoC) of the cell 116. The first relay UE device 101 and the second relay UE device 102 are within coverage of the cell 116. The base station is the serving base station of the first relay UE device 101 and the second relay UE device 102 in the example.

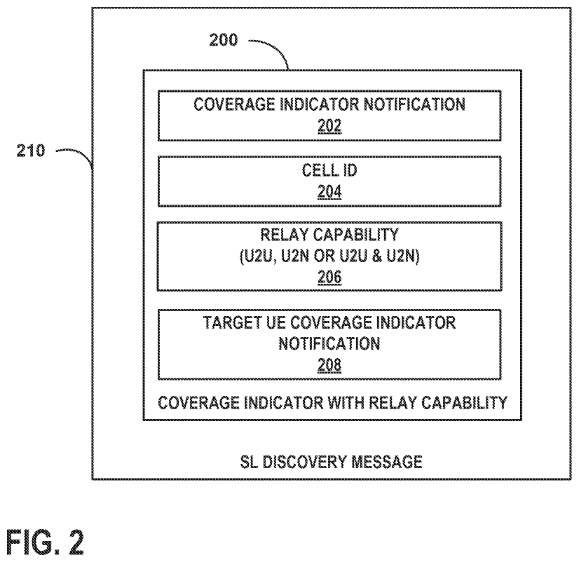

FIG. 2 is a block diagram of an example of a coverage indicator 200 suitable for use in the examples discussed herein. The coverage indicator 200 of FIG. 2, therefore, is an example of the coverage indicators 104-108 discussed above with reference to FIG. 1.

The coverage indicator 200 at least includes a coverage indicator notification 202 that contains information that indicates the relay UE device transmitting the coverage indicator 200 is in coverage of a cell. For the examples herein, the coverage indicator 100 also includes a cell identifier (cell ID) 204 and a relay capability 206. The cell ID 204 uniquely identifies the cell that is providing coverage to the relay UE device that is transmitting the coverage indicator 200. The relay capability 206 indicates whether the relay UE device is capable of providing U2N relay service to connect to the coverage cell, capable of providing U2U relay service to a target UE device, or capable of providing both U2N and U2U relay services (dual relay capability). The ProSe function of the relay UE device determines whether the relay UE device may serve as a U2U relay UE, a U2N relay UE, or both. If the relay UE device can serve as both U2U and U2N relay UE device and it is within coverage and below the configured relay threshold, it may indicate in discovery that it can serve as either type of relay. For discovery Model A messages, the relay capability indicator typically indicates whether it meets the requirements for serving as a U2N and/or a U2U relay UE device. For Model B discovery response messages, the relay capability indicator may also indicate whether it can serve as a U2U relay UE for the specific target UE device.

The coverage indicator 200 may also include a target UE coverage indicator notification 208 which provides coverage information for the target UE device 112 is some situations. After receiving a Model B request message from the remote UE device, for example, the relay UE device may send a Model B request message to the target UE device where the target UE device responds with a discovery message including a coverage indicator. The relay UE device may then include the coverage information of the target UE device in its Model B discovery response to the remote UE device as the target UE coverage indicator notification 108 in the coverage indicator 200.

For the example, the coverage indicator 200 is transmitted in a sidelink (SL) discovery message 210. The discovery message 210 may be in accordance with Model A or Model B discovery. The coverage indicator 200, therefore, is optionally included in the discovery message 210 which is an application layer message that is generated by the ProSe function of the UE device.

The types of information included in a coverage indicator 200 may vary depending on the specific situation. Some types of information may be omitted in some situations. Where the relay UE capability indicates the relay UE device can provide U2N relay service, the coverage indicator notification 202 may be omitted since it would provide redundant information to the indication that the U2N relaying is supported. Also, the remote UE device may receive more than one coverage indicator 200 from the same relay UE device in some situations. This may occur where information has changed or where additional information has become available, such as the coverage information of particular target UE device, for example. In one example, the remote UE device may receive a Model A discovery announcement including a coverage indicator 200 including coverage information from a relay UE device and then receive a Model B discovery response including a second coverage indicator that includes information regarding the specific target UE device such as its coverage information.

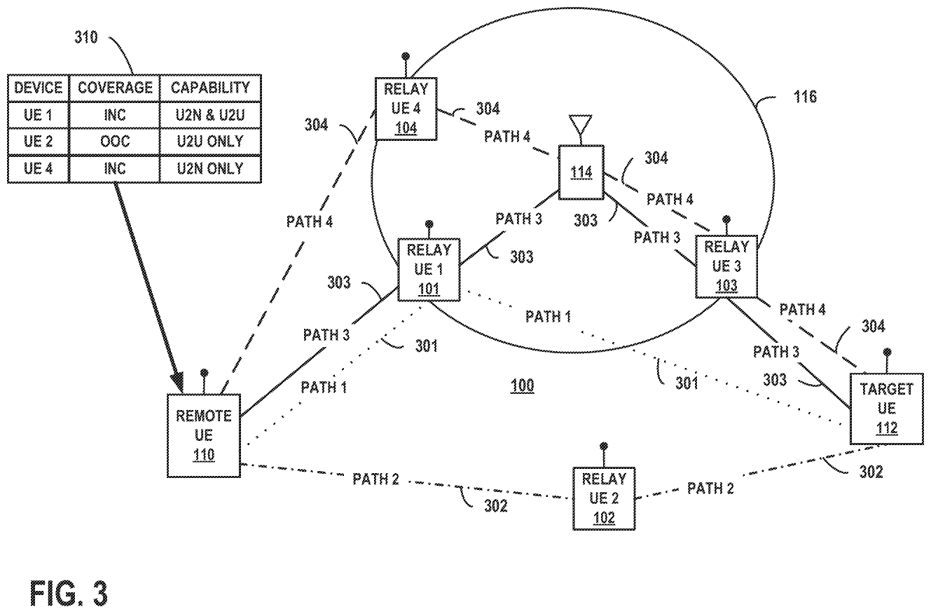

FIG. 3 is a block diagram of the system 100 for an example where the remote UE device has received the cell coverage indicators 105-108 from the candidate devices and is evaluating the paths 301, 302, 303, 304 to connect to the target UE device 112. Although the example includes four paths, the techniques may be applied to any scenario where there are at least two paths. Each relay path 301, 302, 303, 304 connects through at least one UE relay device. In some situations, a relay path may include multiple relay UE devices without including the gNB (not shown in FIG. 3).

A first relay path (path 1) 301 includes connecting to the in-coverage relay UE device 101 which provides U2U relay service to the target UE device 112. A second relay path (path 2) 302 includes connecting to the OoC relay UE device 102 which provides U2U relay service to the target UE device 112. The third relay path (path 3) includes connecting to the first relay UE device 101 which provides U2N relay service to the gNB 114 where the target UE device 112 connects to the gNB 114 through another in-coverage UE relay device (relay UE device 3) 103. A fourth relay path (path 4) 304 includes connecting to the fourth relay UE device 104 which provides U2N relay service to the gNB 114 where the target UE device 112 connects to the gNB 114 through the other in-coverage UE relay device (relay UE device 3) 103.

The remote UE device 110 evaluates coverage and relay capability information 310 obtained from the candidate relay UE devices 101-104 and selects a relay UE device, at least partially, based on the information 310. For the examples herein, the remote UE device and the relay UE devices may exchange multiple discovery messages before obtaining the required information to make a relay selection where the discovery messages may include Model A and Model B discovery. Therefore, the selection procedure may extend over a period of time and is not necessarily performed as a single event. As discussed below, for example, the remote UE device may not make a selection until a timer has expired and/or all expected discovery messages have been received from candidate relay UE devices. The remote UE device applies 110 a selection criterion that may be based on reliability of communication. For the example of FIG. 3, both the first relay UE device 101 and the fourth relay UE device 104 are in coverage of the cell 116 and can provide U2N relay service. The second relay UE device 102 is OoC and likely cannot provide as reliable service as the first and fourth relay UE devices 101, 104. As a result, the section criteria applied by the remote UE device will likely result in a preference of the first and fourth relay UE devices 101, 104 over the second relay UE device 102 if the signal quality threshold criteria are met. Since the first relay UE device 101 also can provide a U2U relay service to the target UE device 112, the remote UE device 110 may select the second UE device 102 over the fourth UE device 104. If the first relay UE device 101 is selected and is providing U2U relay service to the target UE device and the target UE device is no longer in range of PC5 link to the first UE device, there is another route option for service continuity which is to switch from the first relay path 301 to the third relay path 303 without the need for the remote UE device 110 to reselect another relay UE device. A path switch is still required to route the data through the gNB 114 towards the target UE device 112. Where relay UE device can provide both U2N and U2U relay service, the decision on which relay type to use may be decided by the remote UE device, the relay UE device, or the network.

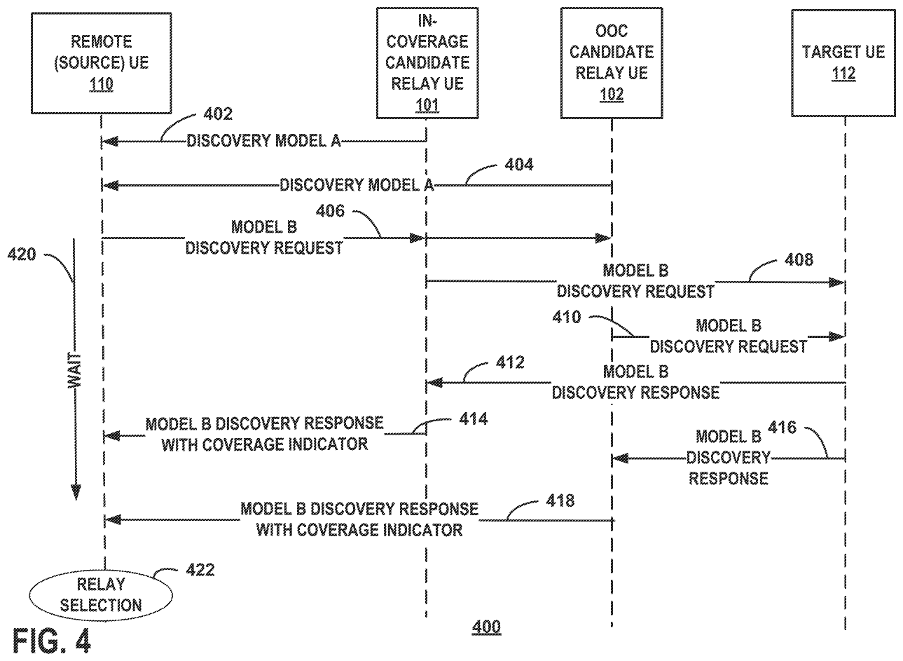

FIG. 4 is a message diagram for an example of discovery message transmission including coverage and relay capability information. For the example, the remote UE device 110 receives coverage indicators 200 from an in-coverage candidate relay UE device 101 and an OoC candidate relay UE device 102. Accordingly, the example of FIG. 4 is one example of communications in the system 100 described with reference to FIG. 3.

At transmission 402, the relay UE device 101 transmits a Model A discovery announcement that is received by the remote UE device 110. At transmission 404, the relay UE device 102 transmits a Model A discovery announcement that is received by the remote UE device 110. For the example, the transmissions 402, 404 include coverage indicators 200 that includes relay capability. Since relay UE device 101 is in coverage, the relay capability in the transmission 402 may indicate that the relay UE device 101 may provide U2N relay service. The coverage indicator notification may be omitted in the transmission 402. The transmission 404 may include a coverage indicator notification indicating the relay UE device 102 is out of coverage and a relay capability indicating the relay UE device 102 meets the requirements for providing U2U service. In some situations, the transmissions 402, 404 may not be received by the remote UE device.

At transmission 406, the remote UE device 110 sends a Model B discovery request that identifies the target UE device 112. The broadcast transmission 406 is received by the in-coverage relay UE device 101 and the OC relay UE device 102.

At transmission 408, the in-coverage relay UE device sends a Model B discovery request in order to determine whether the target relay UE device is within communication range. The transmission 408, therefore, is in response to the transmission 406. Although the in-coverage relay UE device 101 can provide U2N relay service that may be able to form a portion of a relay connection to the target UE device 112, the relay UE device 101 sends the Model B request to determine if the relay UE device 101 can provide U2U relay service to the target UE device.

At transmission 410, the OoC relay UE device 102 sends a Model B discovery request in order to determine whether the target relay UE device 112 is within communication range. The transmission 410, therefore, is in response to the transmission 406.

At transmission 412, the target UE device 112 sends a Model B discovery response to the relay UE device 101. In some situations, the transmission 412 includes coverage information such as a coverage indicator indicating whether the target UE device is in coverage of a cell and the cell ID of the cell.

At transmission 414, the relay UE device 101 sends a Model B discovery response to the remote UE device 110 that includes a coverage indicator 200. The coverage indicator 200 in the transmission 414 includes a relay capability that indicates the relay UE device 101 is capable of providing U2N relay service and U2U relay service. In some situations, the transmission 414 also includes coverage information regarding the target UE device 112 such as a coverage indicator 208 indicating whether the target UE device is in coverage of a cell and the cell ID of the cell.

At transmission 416, the target UE device 112 sends a Model B discovery response to the relay UE device 102. In some situations, the transmission 416 includes coverage information such as a coverage indicator indicating whether the target UE device is in coverage of a cell and the cell ID of the cell.

At transmission 418, the relay UE device 102 sends a Model B discovery response to the remote UE device 110 that includes a coverage indicator 200. The coverage indicator 200 in the transmission 418 includes a relay capability that indicates the relay UE device 101 is capable of only providing U2U relay service. In some situations, the transmission 418 also includes coverage information regarding the target UE device 112 such as a coverage indicator 208 indicating whether the target UE device is in coverage of a cell and the cell ID of the cell.

For the examples herein the remote UE device 110 executes a delay before selecting a relay at event 422. Although the transmissions 414, 418 from all the various candidate relay UE devices are typically received in short time window, the remote UE device waits for time period in order to ensure that all transmissions have been received. In one example, a timer can be initiated after the transmission 406 and the relay selection 422 is not processed until after expiration of the timer. In another timer example, the timer is initiated at the receipt of the first coverage indicator and the relay selection 422 is not processed until after expiration of the timer. In still another timer example, the timer may be somewhat dynamic and established based on a table of Standardized PQI (PC5 5QI (5G Quality Indicator)) values that are additionally defined to QoS characteristics for PC5 with packet delay budget ranging from 10 ms to 400 ms depending on whether the service is GBR (Guaranteed Bit Rate), non-GBR (more delay tolerant) or delay critical GBR (most stringent). The remote UE device applies the delay tolerance as basis for deciding how long to wait for Model B discovery responses. In some cases, doubling the packet delay budget may be feasible, considering the discovery procedure is part of the connection establishment process rather than ongoing data transmission.

In another example, the remote UE device maintains an expected number of candidate relay devices and does not perform relay selection until responses have been received from all the expected devices or a minimum ratio of expected candidate relay devices. The expected number of candidate devices may be determined based on Model A discovery announcements received such as those in the transmissions 402, 404. In some situations, the delay may be based on a combination of a timer and expected number of candidate relay devices. For example, the remote UE device may perform relay selection after timer expiration even if responses have not yet been received from all of the expected candidate relay devices and perform relay selection before timer expiration if responses have been received from all of the expected candidate relay devices.

At event 422, the remote UE device selects or re-selects a relay UE device, at least partially, based on the coverage and capability information received from the candidate relay devices 101, 102.

Therefore, after the remote UE device sends a discover request to the relay UE devices, the relay UE devices send discovery requests to the target UE device to determine if the target is reachable. The relay UE device may convey information to the remote indicative of whether the target UE device is reachable by the relay UE device. In a first example, the relay UE determines that the target UE device is “reachable” and, when the relay UE device sends a Model B response to the remote UE device, the response indicates to the remote UE device that the target is “reachable”. The relay UE device, therefore, is configured/pre-configured with a SD-RSRP (Sidelink Discovery—RSRP) threshold for determining “reachability”. In a second example, the remote UE device determines whether the target device is “reachable”. For the second example, the relay UE device forwards the measured SD-RSRP of the SL to the target UE device and the remote UE device decides whether the SD-RSRP is meets the remote UE device's requirement for relaying through the relay UE device. In addition, the information can be used by the remote UE device to select the best relay UE based on the strongest SD-RSRP. In a third example, a relay UE device determines if the target UE device is reachable based on the SD-RSRP threshold and also forwards the SD-RSRP to the remote UE device in the Model B response message allowing the remote UE device to further determine which relay UE device to select.

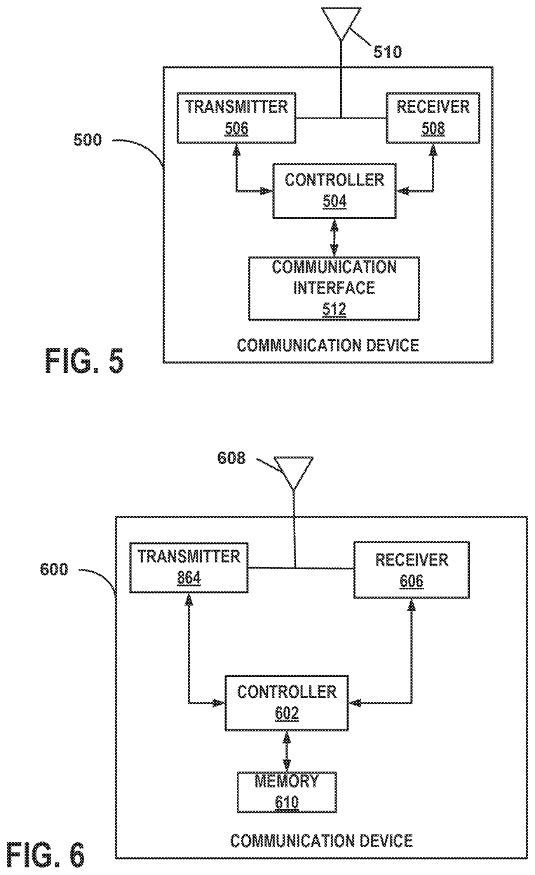

FIG. 5 is a block diagram of an example of a base station 500 suitable for use as the base station 114 and any base station providing a cell or otherwise serving any of the UE devices. The base station 500 includes a controller 504, transmitter 506, and receiver 508, as well as other electronics, hardware, and code. The base station 500 is any fixed, mobile, or portable equipment that performs the functions described herein. The various functions and operations of the blocks described with reference to the base stations 114, 500 may be implemented in any number of devices, circuits, or elements. Two or more of the functional blocks may be integrated in a single device, and the functions described as performed in any single device may be implemented over several devices. The base station 500 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 500 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 500 may be a portable device that is not fixed to any particular location.

The controller 504 includes any combination of hardware, software, and/or firmware for executing the functions described herein as well as facilitating the overall functionality of the base station 500. An example of a suitable controller 504 includes code running on a microprocessor or processor arrangement connected to memory. The transmitter 506 includes electronics configured to transmit wireless signals. In some situations, the transmitter 506 may include multiple transmitters. The receiver 508 includes electronics configured to receive wireless signals. In some situations, the receiver 508 may include multiple receivers. The receiver 508 and transmitter 506 receive and transmit signals, respectively, through an antenna 510. The antenna 510 may include separate transmit and receive antennas. In some circumstances, the antenna 510 may include multiple transmit and receive antennas.

The transmitter 506 and receiver 508 in the example of FIG. 5 perform radio frequency (RF) processing including modulation and demodulation. The receiver 508, therefore, may include components such as low noise amplifiers (LNAs) and filters. The transmitter 506 may include filters and amplifiers. Other components may include isolators, matching circuits, and other RF components. These components in combination or cooperation with other components perform the base station functions. The required components may depend on the particular functionality required by the base station.

The transmitter 506 includes a modulator (not shown), and the receiver 508 includes a demodulator (not shown). The modulator modulates the signals to be transmitted as part of the downlink signals and can apply any one of a plurality of modulation orders. The demodulator demodulates any uplink signals received at the base station 500 in accordance with one of a plurality of modulation orders.

The base station 500 includes a communication interface 512 for transmitting and receiving messages with other base stations. The communication interface 512 may be connected to a backhaul or network enabling communication with other base stations. In some situations, the link between base stations may include at least some wireless portions. The communication interface 512, therefore, may include wireless communication functionality and may utilize some of the components of the transmitter 506 and/or receiver 508.

FIG. 6 is a block diagram of an example of a UE device 600 suitable for use as each of the UE devices 101-104, 110, 112. In some examples, the UE device 600 is any wireless communication device such as a mobile phone, a transceiver modem, a personal digital assistant (PDA), a tablet, or a smartphone. In other examples, the UE device 600 is a machine type communication (MTC) communication device or Internet-of-Things (IoT) device. The UE device 600, therefore is any fixed, mobile, or portable equipment that performs the functions described herein. The various functions and operations of the blocks described with reference to UE device 600 may be implemented in any number of devices, circuits, or elements. Two or more of the functional blocks may be integrated in a single device, and the functions described as performed in any single device may be implemented over several devices.

The UE device 600 includes at least a controller 602, a transmitter 604 and a receiver 606. The controller 602 includes any combination of hardware, software, and/or firmware for executing the functions described herein as well as facilitating the overall functionality of a communication device. An example of a suitable controller 602 includes code running on a microprocessor or processor arrangement connected to memory. The transmitter 604 includes electronics configured to transmit wireless signals. In some situations, the transmitter 604 may include multiple transmitters. The receiver 606 includes electronics configured to receive wireless signals. In some situations, the receiver 606 may include multiple receivers. The receiver 604 and transmitter 606 receive and transmit signals, respectively, through antenna 608. The antenna 608 may include separate transmit and receive antennas. In some circumstances, the antenna 608 may include multiple transmit and receive antennas.

The transmitter 604 and receiver 606 in the example of FIG. 6 perform radio frequency (RF) processing including modulation and demodulation. The receiver 604, therefore, may include components such as low noise amplifiers (LNAs) and filters. The transmitter 606 may include filters and amplifiers. Other components may include isolators, matching circuits, and other RF components. These components in combination or cooperation with other components perform the communication device functions. The required components may depend on the particular functionality required by the communication device.

The transmitter 606 includes a modulator (not shown), and the receiver 604 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

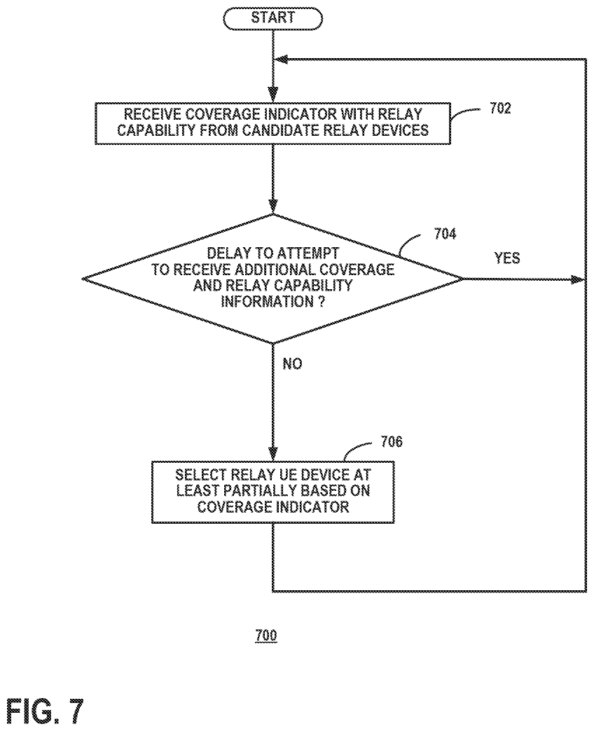

FIG. 7 is a flow chart of an example of a method 600 of selecting a relay UE device based on coverage information. The method, therefore, may be performed by a UE device such as the remote UE device 110 discussed above.

At step 702, coverage indicators with relay capability are received from a plurality of candidate relay UE devices. The remote UE device receives a coverage indicator 200 from each candidate relay UE device in a discovery message. For the example, a coverage indicator 200 from each of plurality candidate relay UE devices is received in a Model B discovery response. As discussed above, each coverage indicator 200 may include any combination if information selected from a coverage indicator notification 202, a cell ID 204, a relay capability 206 and a target UE coverage indicator notification 208.

At step 704, it is determined whether the relay UE device should wait for additional coverage indicators from other candidate relay UE devices. In some situations, the delay may be based on a timer where the timer can be initiated at the transmission of the discovery request by the remote UE device or at the receipt of the first response received from a relay UE device. In other situations, the remote UE device may refrain from relay selection until a threshold number of responses have been received from candidate relay UE devices. For example, where a number of candidate relay devices have been identified based on previously received Model A discovery announcements, the remote UE device 110 may wait until a response from at least a threshold portion of the total number of identified candidate relay UE devices is received. In still other situations, a combination of a timer and a threshold number of responses may determine the delay. For example, where a relay UE device cannot reach the target UE, the relay UE device does not send a Model B discovery response to the remote UE device. As a result, if the threshold number of responses has not been reached, the remote UE device may continue delaying. Without further delay criteria, the remote UE device could delay much longer than needed. Accordingly, including a timer in addition to the threshold number of responses can reduce latency when one or more of the candidate relay devices do not send responses (or responses are otherwise not received). When the threshold number of responses has been received by the remote UE device, the timer can be stopped before expiration and the remote UE device can proceed to select a relay UE device which also reduces latency compared to only having basing the delay on a timer. If delay is required, the method returns to step 704. Otherwise, the method continues at step 706

At step 706, the remote UE evaluates the information provided in the coverage indicators with relay capability to select a relay UE device. The remote UE device evaluates the different paths to the target UE device and selects the relay UE device that is likely to provide the most reliable path. In some situations, paths with in-coverage relay UE devices are preferred to those including an OoC relay UE device. Further, connections to a relay provide U2N relay service may be preferred to U2U paths. This may be the case where the target UE device is in coverage. Other criteria may also be applied.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A relay user equipment (UE) device comprising:
a controller configured to determine whether the relay UE device is capable of providing relay service to each of a target UE device and a base station, the controller configured to select a relay capability indicator from a set comprising a U2U relay only indicator, a U2N relay only indicator, and a dual relay indicator, the U2U relay only indicator selected when the relay UE device is capable of providing relay service to a target UE device without relay service to the base station, the U2N relay only indicator selected when the relay UE device is capable of providing relay service to the base station without relay service directly to the target UE device, the dual relay indicator selected when the relay UE device is capable of providing relay service to the base station and relay service to the target UE device, and
a transmitter configured to transmit a sidelink discovery message comprising the relay capability indicator.

2. The relay UE device of claim 1, wherein the transmitter is further configured to transmit the sidelink discovery message comprising a cell identifier of the base station.

3. The relay UE device of claim 2, further comprising:
a receiver configured to receive a Model B discovery request message from a remote UE device, the Model B discovery request message identifying the target UE device.

4. The relay UE device of claim 3, wherein the transmitter is further configured to transmit another Model B discovery request message to the target UE device, the receiver further configured to receive, from the target UE device, a Model B discovery response message comprising target UE coverage indicator indicating whether the target UE device is in coverage of a cell, the sidelink discovery message comprising information indicative of the target UE coverage indicator.

5. The remote user equipment (UE) device comprising:
a receiver configured to receive a coverage indicator from each of a plurality or candidate relay UE devices, each coverage indicator indicating whether the candidate relay UE device transmitting the coverage indicator is in coverage of a cell; and
a controller configured to select, from the plurality of candidate relay UE devices, a selected relay UE device for providing a relay connection to a target UE device.

6. The remote UE device of claim 5, wherein coverage indicator comprises a cell identifier uniquely identifying the cell.

7. The remote UE device of claim 5, wherein the coverage indicator comprises a relay capability indicator selected from a set comprising a U2U relay only indicator, a U2N relay only indicator, and a dual relay indicator, the U2U relay only indicator selected when the relay UE device is capable of providing relay service to a target UE device without relay service to the base station, the U2N relay only indicator selected when the relay UE device is capable of providing relay service to the base station without relay service directly to the target UE device, the dual relay indicator selected when the relay UE device is capable of providing relay service to the base station and relay service to the target UE device.

8. The remote UE device of claim 5, wherein the controller is configured to select the selected relay UE device based one or more communication paths from the remote UE device to the target UE device capable of being provided by each of the plurality of candidate relay UE devices.

9. The remote UE device of claim 8, wherein the controller is configured to select the selected relay UE device based an expected reliability of the communication paths.

10. The remote UE device of claim 5, further comprising:
a transmitter configured to transmit a Model B discovery request identifying the target UE device, the receiver configured to receive a plurality of Model B discovery responses, each of the Model B discovery responses comprising one of the coverage indicators.

11. The remote UE device of claim 10, wherein at least one of the coverage indicators comprises a target UE coverage indicator indicating whether the target UE device is in coverage of a cell.

12. The remote UE device of claim 10, wherein the controller is further configured to:
initiate a timer when the transmitter transmits a Model B discovery request; and
delay selecting the selected relay UE device until the timer has expired.

13. The remote UE device of claim 10, wherein the controller is further configured to:
initiate a timer when the receiver receives a first Model B discovery response of the plurality of Model B discovery responses; and
delay selecting the selected relay UE device until the timer has expired.

14. The remote UE device of claim 10, wherein the controller is further configured to:
determine a threshold number of coverage indicators based on an expected number of candidate relay UE devices; and
delay selecting the selected relay UE device until the threshold number of coverage indicators is received.
